(19) United States
(12) Patent Application Publication
(10) Pub. No.: US 2008/0310199 A1
(43) Pub. Date: Dec. 18, 2008

(54) POWER SUPPLY PROTECTION APPARATUS AND RELATED METHOD

(76) Inventors: Yueh-Chang Tsai, Hsinchu County (TW); Fu-Chun Huang, Taichung City (TW); Hui-Tsung Yang, Taipei County (TW); Su-Yuan Lin, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/135,199

(22) Filed: Jun. 8, 2008

Related U.S. Application Data
(60) Provisional application No. 60/944,099, filed on Jun. 15, 2007.

(51) Int. Cl. H02H 7/10

(52) U.S. Cl. 363/50

(57) ABSTRACT

A power supply protection method for a power supply device includes: detecting whether an output voltage of the power supply device reaches a voltage protection threshold to generate a detection result; generating a first control signal according to a power good input signal and the detection result; utilizing a fault protection circuit to decide whether to output a fault protection signal according to the first control signal; and using a short circuit protection circuit to receive the power good input signal and determining whether to generate a second control signal according to the power good input signal. When the power good input signal is not enabled during a specific time after the power supply device is started, the short circuit protection circuit is directly used to generate the second control signal into the fault protection circuit for triggering the fault protection circuit to output the fault protection signal.

### CROSS REFERENCE TO RELATED APPLICATIONS

This application claims the benefit of U.S. Provisional Application No. 60/944,099, which was filed on Jun. 15, 2007 and is included herein by reference.

### BACKGROUND OF THE INVENTION

1. Field of the Invention

The present invention relates to a power supply protection scheme, and more particularly, to a power supply protection apparatus for rapidly activating a power protection mechanism, and a method thereof.

2. Description of the Prior Art

Generally speaking, a conventional power supply protection scheme used for protecting a power supply device is aware of whether the power supply device or the AC power received by the power supply device itself is abnormal or not by detecting the voltage level of a power good input signal. Please refer to FIG. 1. FIG. 1 is a diagram of a conventional switching power supply device 100. As shown in this figure, the power good input signal S_{PGI} is pulled from an intermediate node between a secondary-side coil of the transformer 105 and the output filter 110 in the power supply device 100. The reason for using the power good input signal S_{PGI} to know whether the power supply device 100 or AC power S_{AC} is abnormal is that the switching rate of the output voltage Vₒᵤₜ at the time axis is lower than that of the power good input signal S_{PGI} due to the output filter 110. That is, when the state of the AC power signal received by the primary-side coil of the transformer 105 and the pulse width modulation (PWM) signal S_{PWM} received by the transformer 105 alter, the power good input signal S_{PGI} is enabled/disabled earlier than the output voltage Vₒᵤₜ. The power good input signal S_{PGI} can rapidly reflect the state of the AC power signal received at the primary-side coil of the transformer 105 more than the output voltage Vₒᵤₜ. Accordingly, the power good input signal S_{PGI} is more applicable for detecting whether the power supply device 100 or AC power S_{AC} is abnormal or not.

Please refer to FIG. 2. FIG. 2 is a diagram illustrating waveforms of the power good input signal S_{PGI} and output voltage Vₒᵤₜ shown in FIG. 1. As shown in FIG. 2, after the power good input signal S_{PGI} is enabled at the timing T₁, the output voltage Vₒᵤₜ slowly rises to a voltage level at which the power supply device 100 operates normally. Thus, after determining that the power good input signal S_{PGI} has been enabled, a power supply protection circuit must wait for a delay time T_{delay} so that the level of the output voltage Vₒᵤₜ is higher than that of an under voltage boundary Vᵤᵥ_{_{—}}_{boundary} when the power supply device 100 operates normally. Afterwards the power supply protection circuit begins to decide whether an under voltage arises in the output voltage Vₒᵤₜ or not. If the AC power S_{AC} is disabled, the output voltage Vₒᵤₜ decreases naturally and then the power supply protection circuit determines that the power good input signal S_{PGI} has been disabled before the level of the output voltage Vₒᵤₜ is lower than that of the under voltage boundary Vᵤᵥ_{_{—}}_{boundary}. As a result, the power supply protection circuit can immediately stop the under voltage protection operation, e.g., at the timing T₂, to avoid an erroneous operation to the power supply device 100.

Please refer to FIG. 3. FIG. 3 is a block diagram of a conventional power supply protection circuit 300. As shown in FIG. 3, the power supply protection circuit 300 includes an over/under voltage protection circuit 305, an under voltage protection control circuit 310, a fault protection circuit 315, and a power good circuit 320. The over/under voltage protection circuit 305 detects the level of the output voltage Vₒᵤₜ of the power supply device 100 shown in FIG. 1, such as 12 Volts, 5 Volts, and 3.3 Volts, and then outputs different detection results to the under voltage protection control circuit 310 and fault protection circuit 315 respectively. If an over voltage arises in the output voltage Vₒᵤₜ, a fault protection signal S_{FPOB} will be outputted by the fault protection circuit 315 for indicating that the output voltage Vₒᵤₜ is abnormal. In addition, when the power good input signal S_{PGI} and a power supply on/off control signal S_{PSON} are enabled, the under voltage protection control circuit 310 detects whether a detection result outputted from the over/under voltage protection circuit 305 indicates that an under voltage arises in the output voltage Vₒᵤₜ. If an under voltage arises in the output voltage Vₒᵤₜ, then the under voltage protection control circuit 310 will control the fault protection circuit 315 to output the fault protection signal S_{FPOB}. If no over/under voltages arise in the power good input signal S_{PGI} when the power good input signal S_{PGI} is enabled, the power good circuit 320 will output a power good output signal S_{PGO} for expressing that the output voltage Vₒᵤₜ provided by the power supply device 100 is not abnormal. The over/under voltage protection circuit 305, under voltage protection control circuit 310, and the power good circuit 320 are all controlled by the power supply on/off control signal S_{PSON}.

For the above-mentioned under voltage protection operation, it is assumed that the power good input signal S_{PGI} can be enabled during each startup of the power supply device 100, where startup of the power supply device 100 usually means the AC power S_{AC} and power supply on/off control signal S_{PSON} are enabled. In an actual power system, however, there is a possibility that the power good input signal S_{PGI} cannot be enabled; for example, the power good input signal S_{PGI} may be short to ground during startup of the power supply device 100. In this situation, the under voltage protection control circuit 310 will not detect whether a detection result has been generated for checking if an under voltage arises or not. Therefore, it is very possible that the output voltage Vₒᵤₜ is maintained at a lower level but the under voltage protection control circuit 310 does not protect the output voltage Vₒᵤₜ of the power supply device 100 by using the fault protection circuit 315 to output the fault protection signal S_{FPOB}. To solve the above-described problem, a conventional scheme is provided according to Taiwan patent No. 488,579; further description is illustrated in FIG. 4. As shown in FIG. 4, a power supply protection circuit uses a timer control circuit 31 to detect whether a power good input signal PGI has been enabled or not. If the power good input signal PGI is not enabled after the timer control circuit 31 counts a time period, a third delay circuit 30 is enabled and then an under voltage protection control circuit 24 performs under voltage protection operation upon an output voltage Vₒᵤₜ. If an under voltage arises in the output voltage Vₒᵤₜ, the under voltage protection control circuit 24 will detect a result outputted from an over/under voltage protection circuit 21 and then a fault protection signal FPL_N will be outputted to the AC power system from a latch circuit 23. An disadvantage of the power supply protection circuit is that an abnormal increase of load to the power supply device 100 will result from an under voltage arising in the power good input signal PGI; for instance, an under voltage arises in the power good input signal PGI when the power good input signal PGI is short to ground. Another drawback is: a crisis in which the output voltage Vₒᵤₜ of the power supply device 100 cannot be protected normally. This occurs when an under voltage arises in the power good input signal PGI since the under voltage protection operation may be cancelled. In addition, because the operation of the power supply protection circuit is accomplished in two phases when the power good input signal PGI is not enabled (i.e., the operations of the timer control circuit 31 and under voltage protection control circuit 24 are both required), it is necessary to wait for a longer time period before performing the under voltage protection operation. This causes more serious damage to the power supply device 100.

### SUMMARY OF THE INVENTION

Therefore, one of the objectives of the present invention is to provide a power supply protection apparatus and related method for rapidly performing a power protection operation, to solve the above-mentioned problems.

According to an embodiment of the present invention, a power supply protection apparatus for protecting a power supply device is disclosed. The power supply protection apparatus comprises a voltage protection circuit, a voltage protection control circuit, a fault protection circuit, and a short circuit protection circuit. The voltage protection circuit is utilized for detecting whether an output voltage of the power supply device reaches a voltage protection threshold or not for generating a detection result. The voltage protection control circuit is coupled to the voltage protection circuit, and used for generating a first control signal according to a power good input (PGI) signal and the detection result. The fault protection circuit is coupled to the voltage protection control circuit and utilized for determining whether to output a fault protection signal according to the first control signal, and the short circuit protection circuit is directly connected to the fault protection circuit and used for receiving the power good input signal and determining whether to generate a second control signal according to the power good input signal. In addition, the short circuit protection circuit generates the second control signal to trigger the fault protection circuit for outputting the fault protection signal when the power good input signal is not enabled during a specific time after the power supply device is started.

According to the embodiment of the present invention, a power supply protection method for protecting a power supply device is further disclosed. The power supply protection method comprises the following steps: detecting whether an output voltage of the power supply device reaches a voltage protection threshold to generate a detection result; generating a first control signal according to a power good input signal and the detection result; providing a fault protection circuit, and using the fault protection circuit to determine whether to output a fault protection according to the first control signal; and providing a short circuit protection circuit and using the short circuit protection circuit to receive the power good input signal and to determine whether to generate a second control signal according to the power good input signal. The short circuit protection circuit is directly used for generating the second control signal to the fault protection circuit to trigger the fault protection circuit for outputting the fault protection signal when the power good input signal is not enabled during a specific time after the power supply device is started.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional switching power supply device.

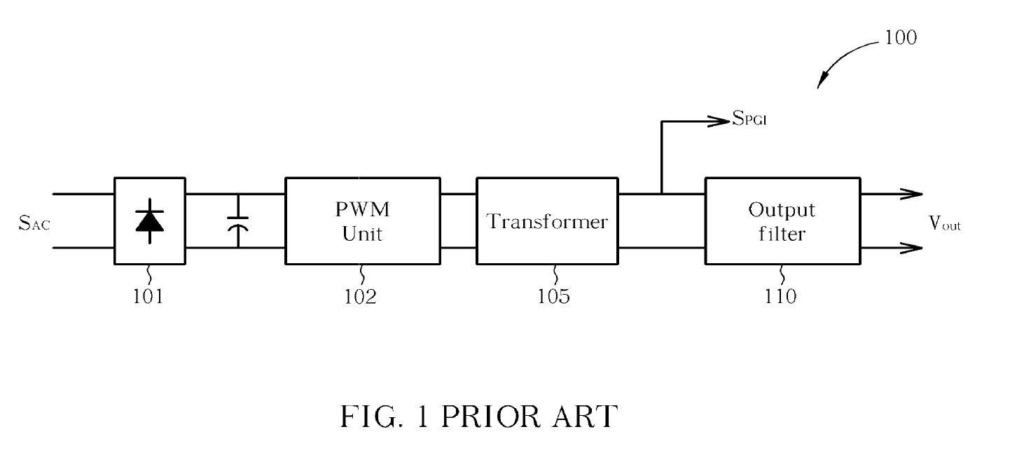

FIG. 2 is a diagram illustrating waveforms of the power good input signal and output voltage shown in FIG. 1.

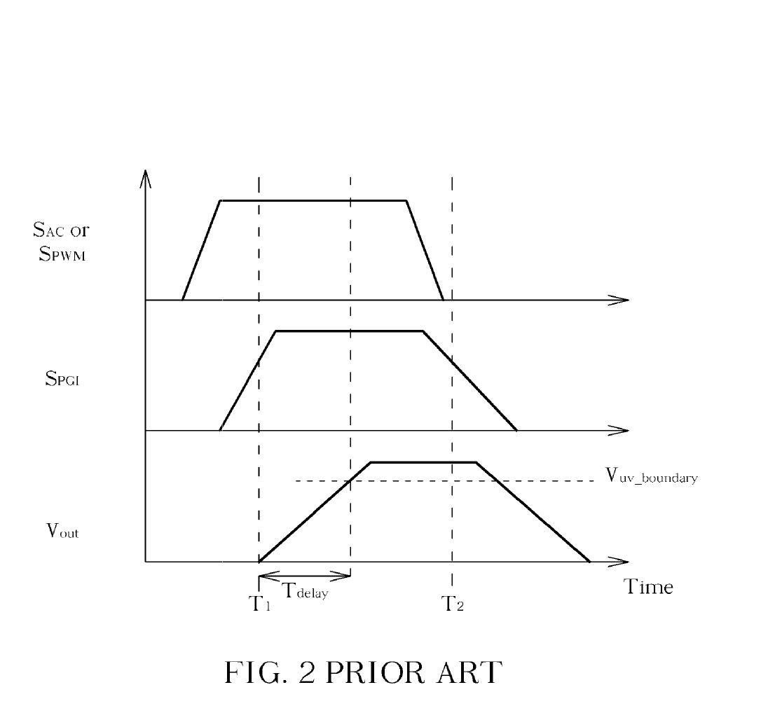

FIG. 3 is a block diagram of a conventional power supply protection circuit.

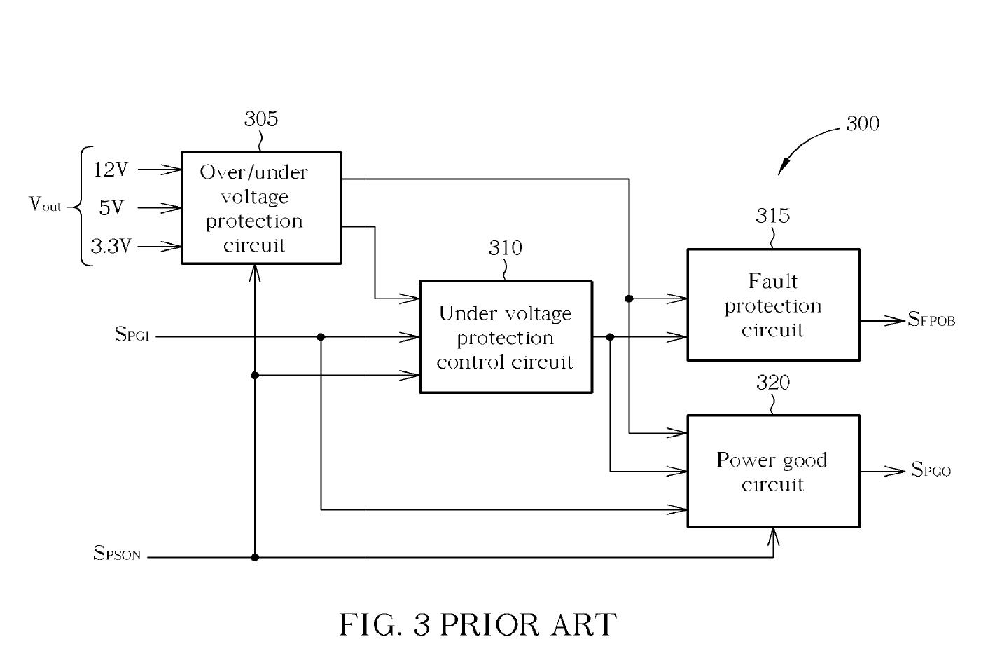

FIG. 4 is a diagram of another conventional power protection circuit.

FIG. 5 is a simplified diagram of a power supply protection apparatus according to an embodiment of the present invention.

### DETAILED DESCRIPTION

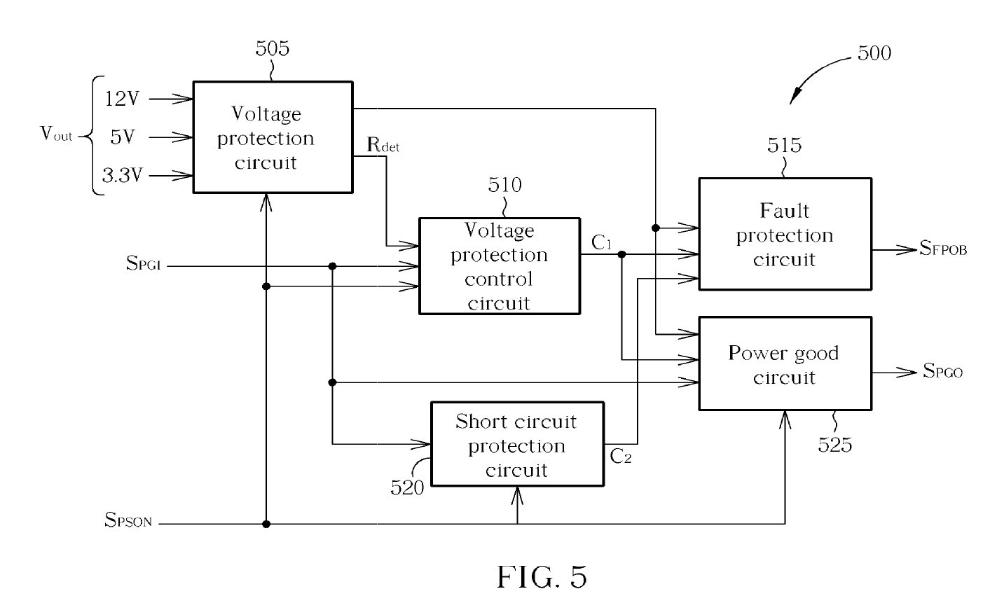

Please refer to FIG. 5. FIG. 5 is a simplified diagram of a power supply protection apparatus 500 according to an embodiment of the present invention. As shown in FIG. 5, the power supply protection apparatus 500 includes a voltage protection circuit 505, a voltage protection control circuit 510, a fault protection circuit 515, a short circuit protection circuit 520, and a power good circuit 525. In this embodiment, the voltage protection circuit 505 is an over/under voltage protection circuit and utilized for detecting whether an output voltage Vₒᵤₜ of a power supply device reaches a voltage protection threshold or not, for generating a detection result R_{det}. Taking the operation of under voltage protection function as an example, the voltage protection circuit 505 generates the detection result R_{det} when the output voltage Vₒᵤₜ is lower than the voltage protection threshold. Of course, this is not intended to be a limitation of the present invention; the voltage protection circuit 505 can also be implemented by an under voltage protection circuit. The voltage protection control circuit 510 generates a first control signal C₁ according to a power good input signal S_{PGI} and the detection result R_{det}, and the fault protection circuit 515 is used for outputting a fault protection signal S_{FPOB} according to the first control signal C₁. The short circuit protection circuit 520 is directly connected to the fault protection circuit 515, and utilized for receiving the power good input signal S_{PGI} and determining whether to generate a second control signal C₂ according to the power good input signal S_{PGI}. When the power good input signal S_{PGI} is not enabled during a specific time after the power supply device is started (the short circuit protection circuit 520 will determine that the power good input signal S_{PGI} is not enabled if the power good input signal S_{PGI} still remains at a low logic level, for example), the short circuit protection circuit 520 generates the second control signal C₂ to trigger the fault protection circuit 515 for outputting the fault protection signal S_{FPOB}. In contrast, when the power good input signal S_{PGI} is enabled during the specific time, the short circuit protection circuit 520 will be disabled, i.e., the operation of the short circuit protection circuit 520 will be stopped. In this embodiment, the over voltage detection operation of the voltage protection circuit 505 and the operation of the power good circuit 525 are similar to those of the over/under voltage protection circuit 305 and the power good circuit 320, respectively; further description is not detailed here for brevity.

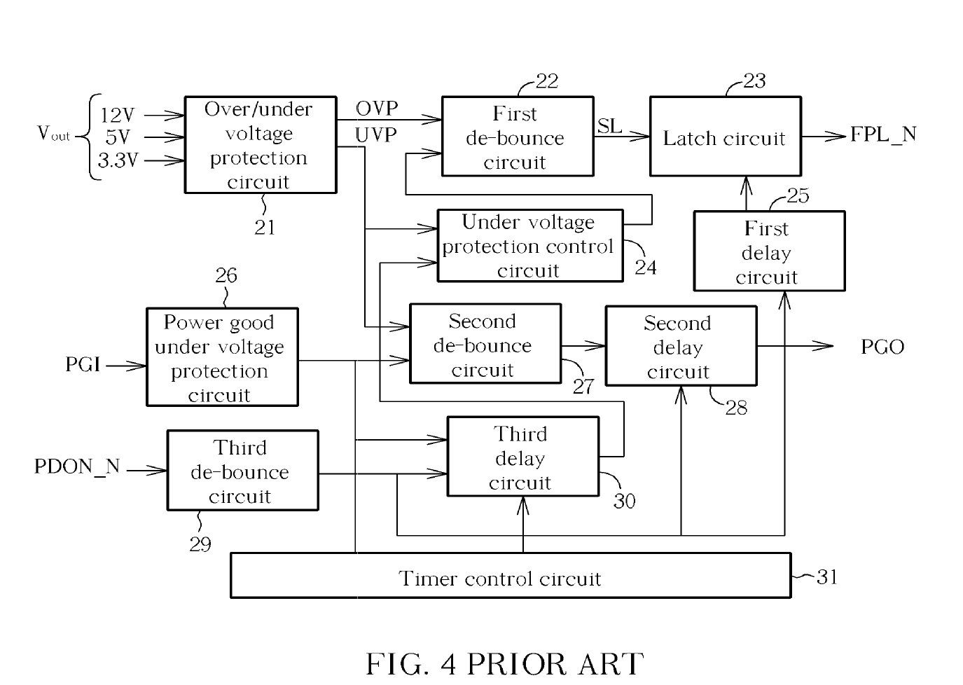

In detail, since the short circuit protection circuit 520 is directly connected to the fault protection circuit 515, the short circuit protection circuit 520 can directly output the second control signal C₂ to trigger the fault protection circuit 515 when determining that the power good input signal S_{PGI} still remains at the low logic level during the specific time after the power supply device is started, for outputting the fault protection signal S_{FPOB} to indicate that the AC power received by the power supply device is abnormal. Otherwise, when the power good input signal S_{PGI} is switched to a high logic level during the specific time (i.e. the power good input signal S_{PGI} is enabled), the operation of the short circuit protection circuit 520 is stopped immediately but the under voltage protection operation can still be completed by the voltage protection control circuit 510. In other words, if an under voltage arises in this situation, the voltage protection control circuit 510 outputting the first control signal C₁ to trigger the fault protection circuit 515 for outputting the fault protection signal S_{FPOB} to indicate that there is a fault related with the AC power can also be achieved. It should be noted that delay circuits are not displayed in FIG. 5 for simplifying the circuit configuration of this embodiment. In practice, delay circuits similar to those shown in FIG. 4, however, are required for correctly completing operation of the power supply protection apparatus 500.

As mentioned above, if an under voltage occurs, in practice the power supply protection apparatus 500 can perform the under voltage protection operation by the short circuit protection circuit 520 more rapidly than in the prior art. In theory, the power good input signal S_{PGI} is pulled from an intermediate node between a secondary-side coil of a transformer and an output filter, and is used as a basis for determining whether to perform voltage/current protection or not. Only when the power good input signal S_{PGI} is enabled, the voltage protection circuit 505 monitors the output voltage Vₒᵤₜ; otherwise, the voltage protection circuit 505 does not monitor the output voltage Vₒᵤₜ. Accordingly, a change in the power good input signal S_{PGI} can be equivalently regarded as a basis for enabling/disabling the under voltage protection operation. In the present invention, the power good input signal S_{PGI} is further used as a benchmark for deciding whether the AC power is normal or not. This is because the power good input signal S_{PGI} can reflect the condition of the AC power. If the power good input signal S_{PGI} is abnormal, then this usually means that the AC power at a primary-side coil of the transformer also becomes abnormal. Therefore, after start-up of the power supply protection apparatus 500, by using the short circuit protection circuit 520 to decide if the power good input signal S_{PGI} is abnormal or not, the power supply protection apparatus 500 can directly determine whether to output the second control signal C₂ to trigger the fault protection circuit 515 for outputting the fault protection signal S_{FPOB}, without enabling the voltage protection control circuit 510 again to detect whether the detection result R_{det} has been generated or not for activating the under voltage protection operation. For example, in an abnormal condition, if the power good input signal S_{PGI} still remains at a low logic level during a specific time after the power supply device is started, there is a possibility that the power good input signal S_{PGI} is short to ground. Compared to the prior art teachings, damage to the AC power or a back-end system can be therefore avoided, where the damages are caused by abnormal voltage level(s) of the AC power itself due to disablement of the power good input signal S_{PGI}.

In addition, it should be noted that the power supply protection apparatus 500 in this embodiment is applicable to all kinds of switching power supply devices; of course, this is applicable to different kinds of power supply devices, such as forward power supply converters or flyback power supply converters. All of these fall within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power supply protection apparatus for protecting a power supply device, comprising:
a voltage protection circuit, for detecting whether an output voltage of the power supply device reaches a voltage protection threshold for generating a detection result;
a voltage protection control circuit, coupled to the voltage protection circuit, for generating a first control signal according to a power good input signal and the detection result;
a fault protection circuit, coupled to the voltage protection control circuit, for outputting a fault protection signal according to the first control signal; and
a short circuit protection circuit, directly connected to the fault protection circuit, for receiving the power good input signal and determining whether to generate a second control signal according to the power good input signal; wherein when the power good input signal is not enabled during a specific time after the power supply device is started, the short circuit protection circuit generates the second control signal to trigger the fault protection circuit for outputting the fault protection signal.

2. The power supply protection apparatus of claim 1, wherein the voltage protection circuit is an under voltage protection circuit for generating the detection result when the output voltage is lower than the voltage protection threshold.

3. The power supply protection apparatus of claim 2, wherein the short circuit protection circuit determines that the power good input signal is not enabled when the power good input signal remains at a low logic level during the specific time.

4. The power supply protection apparatus of claim 1, wherein the short circuit protection circuit determines that the power good input signal is not enabled when the power good input signal remains at a particular logic level during the specific time.

5. The power supply protection apparatus of claim 1, wherein the short circuit protection circuit is disabled when the power good input signal is enabled during the specific time.

6. A power supply protection method for protecting a power supply device, comprising:
detecting whether an output voltage of the power supply device reaches a voltage protection threshold for generating a detection result;
generating a first control signal according to a power good input signal and the detection result;
providing a fault protection circuit, and utilizing the fault protection circuit to decide whether to output a fault protection signal according to the first control signal; and
providing a short circuit protection circuit, and utilizing the short circuit protection circuit to receive the power good input signal and determining whether to generate a second control signal according to the power good input signal, wherein when the power good input signal is not enabled during a specific time after the power supply device is started, using the short circuit protection circuit to directly generate the second control signal into the fault protection circuit to trigger the fault protection circuit for outputting the fault protection signal.

7. The power supply protection method of claim 6, wherein the step of detecting whether the output voltage reaches the voltage protection threshold for generating the detection result comprises:
providing an under voltage protection threshold as the voltage protection threshold, and generating the detection result when the output voltage is lower than the under voltage protection threshold.

8. The power supply protection method of claim 7, further comprising:
determining that the power good input signal is not enabled when the power good input signal remains at a low logic level during the specific time.

9. The power supply protection method of claim 6, further comprising:
determining that the power good input signal is not enabled when the power good input signal remains at a particular logic level during the specific time.

10. The power supply protection method of claim 6, further comprising:
disabling the short circuit protection circuit when the power good input signal is enabled during the specific time.
